(19) United States
(12) Patent Application Publication
(10) Pub. No.: US 2005/0013401 A1
(43) Pub. Date: Jan. 20, 2005

(54) Boiling water reactor refuel cavity work platform

(76) Inventors: Robert E. Markling, Cold Springs, MN (US); Charles M. Hill, Hartselle, AL (US)

Correspondence Address: VYTAS R. MATAS, 2412 CEDARWOOD RD., PEPPER PIKE, OH, 44124, US

(21) Appl. No.: 10/881,054

(22) Filed: Jun. 30, 2004

Related U.S. Application Data
(60) Provisional application No. 60/484,549, filed on Jul. 2, 2003.

(51) Int. Cl. G21C 19/00

(52) U.S. Cl. 376/263

(57) ABSTRACT

The present invention comprises a portable work station for use during reactor refueling operation to allow inspection/repair of the reactor vessel simultaneously with the removal insertion of fuel cells from and into the reactor due to the work station being sized to fit into the reactor vessel spaced from the wall of the vessel and still clear of the fuel cell area of the reactor vessel to provide a direct view of the wall to personnel on the work platform while the refueling operation is ongoing.

### BACKGROUND OF THE INVENTION

1. Field of the Invention

The present application is generally drawn to Boiling Water Reactor (BWR) work platforms and more particularly to portable work platforms installed over the reactor cavity during refueling of the reactor.

2. Description of the Prior Art

Much of the maintenance performed in nuclear power plants is similar to that for conventional non-nuclear systems. This includes equipment lubrication, fluid level checks and adjustments. Because most of the active systems are fluid (water, steam or air) systems, most of the work is performed on pumps, valves, fans and filters. In addition, the electrical distribution systems and the instrument and control (IC) systems require regularly scheduled maintenance. As previously discussed, nuclear systems are unique in that many components are inaccessible.

The reactor vessel and its internals are static components requiring little maintenance. Activities that are performed during each refueling outage focus on the integrity of the reactor vessel. During refueling, the reactor head must be removed from the vessel to gain access to the core. When this is done the irradiated fuel elements are removed and replaced with new active fuel elements. This is also the time when the various vessel components are inspected for wear and defects. The process of fuel removal and vessel inspection was done in series in previous installations.

A work platform was erected during this fuel removal process and was used for the mentioned inspection functions. Various such inspection platforms or decks are known and some may be found in the following US patents.

U.S. Pat. No. 5,102,612 provides a permanent deck structure or platform that is outside of the reactor cavity and allows remote access to the reactor annulus for inspection and repair if necessary.

U.S. Pat. No. 5,359,632 provides an annular plate around the outside of the reactor with inner and outer support rings with access ports therein. Thus inspection is done remotely to the cavity.

U.S. Pat. No. 5,295,167 teaches an auxiliary refueling bridge work platform mounted on a rigid frame adjacent the work station. The platform is attached to a movable platform crane which is positioned to allow the use of the platform. As such this platform can not be used during refueling.

In view of the above known platforms it will be seen that a platform which could be used simultaneously with the refueling operation and which would fit inside the reactor cavity to allow inspection and repair of the cavity from the cavity location was sorely needed.

### SUMMARY OF THE INVENTION

The present invention solves the mentioned problems of the prior art work platforms and others by providing a work platform for a BWR which is installed into the refueling cavity of the BWR so as to leave the fuel elements exposed to allow simultaneous inspection and repair of the cavity and removal and replacement of the individual fuel elements during the refueling process.

The platform is formed as an annular ring with inner and outer railings allowing a plurality of workers to be on the platform to simultaneously provide inspection and repair functions. The platform is situated on a series of s-shaped brackets extending into the cavity from the edge of the reactor cavity.

In view of the above it will be seen that one aspect of the present invention is to provide a reactor refueling platform which is situated inside the reactor cavity to allow simultaneous inspection/repair as well as fuel removal and insertion.

Another aspect is to provide a work platform for reactor refueling which is located inside the reactor cavity to allow local inspection/repair of the cavity.

These and other aspects of the present invention will be more fully understood after a perusal of the following description of the preferred embodiment, when considered along with the accompanying drawings.

### BRIEF DESCRIPTION OF THE DRAWINGS

In the drawings wherein:

FIG. 1 is an orthographic view of the work platform as installed in the cavity of a BWR during refueling operation.

FIG. 2 is a top view of the work platform as mounted on the BWR during refueling.

FIG. 3 is an expanded side view of the work platform as located in the reactor cavity.

FIG. 4 is a side view of the s-shaped brackets holding the work platform in the reactor cavity.

FIG. 5 is a top view of the work platform as sitting on the s-shaped brackets.

FIG. 6 is an enlarged sectional side view of the work platform and railings.

FIG. 7 is a sectional side view of the work platform and brackets of FIG. 5.

### DESCRIPTION OF THE PREFERRED EMBODIMENT

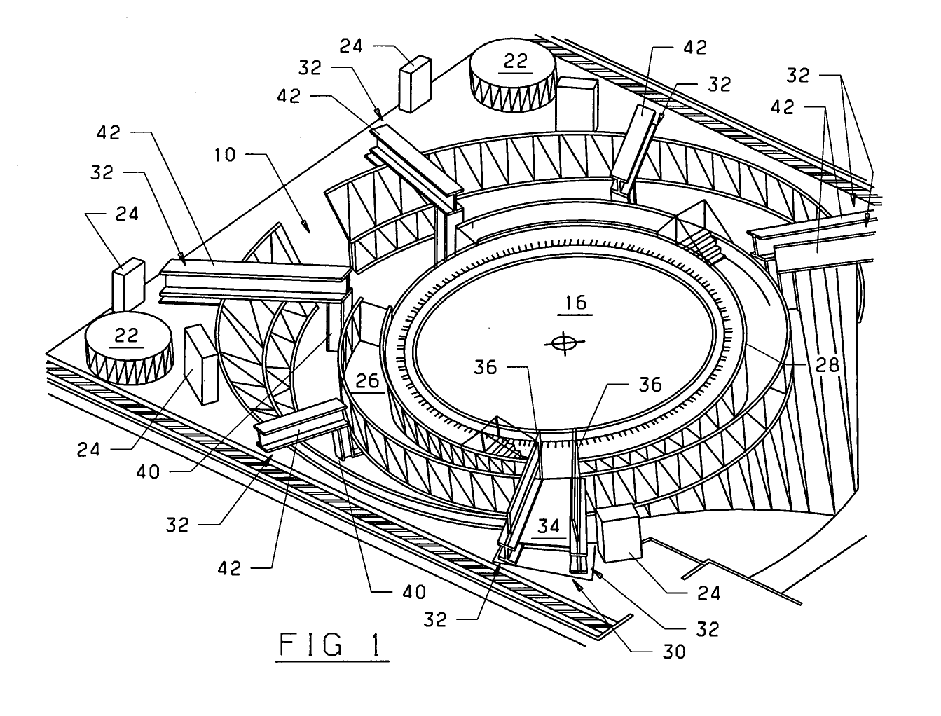

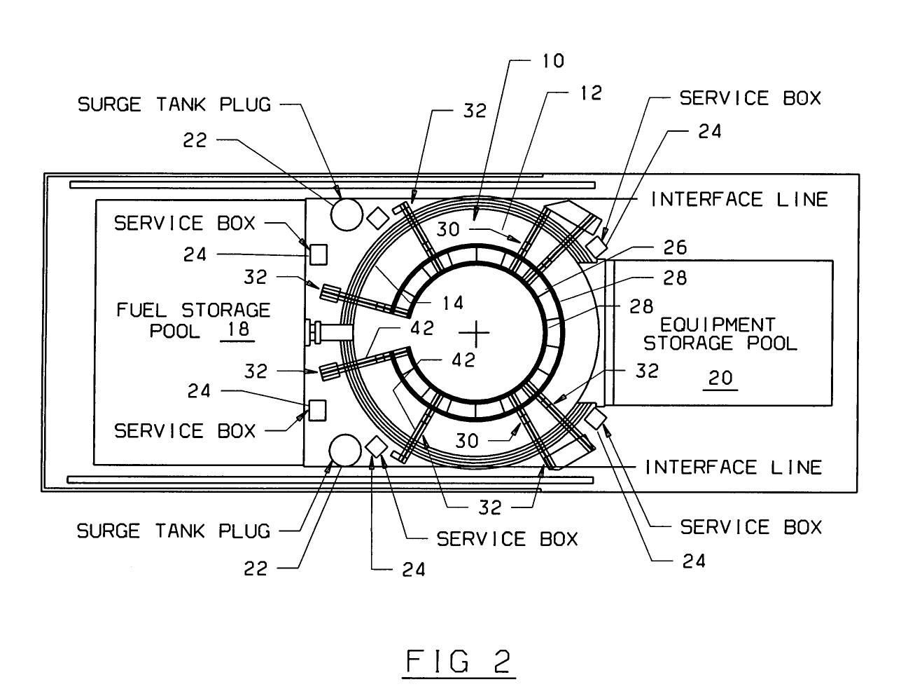

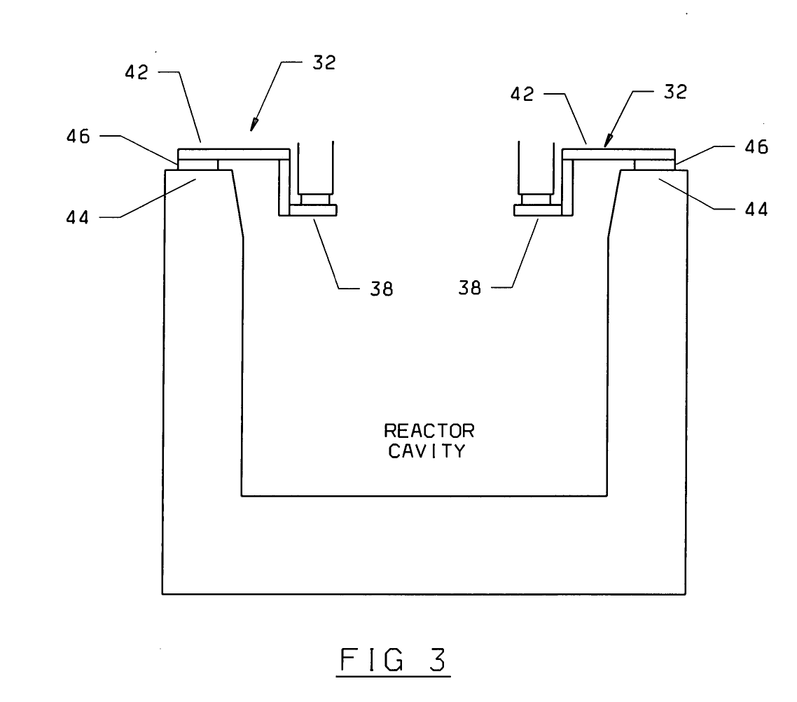

Referring now to the drawings generally and FIGS. 1 and 2 in particular, a work platform assembly (10) is shown located inside the BWR reactor cavity (12) spaced from the wall (14) to allow inspection/repair of the cavity wall (14) and components but clear of the reactor fuel cell area (16) to allow both ht repair/inspection function and fuel element replacement function to be simultaneously provided. The fuel replacement area includes ancillary facilities such as a fuel storage pool (18) for storing spent fuel cells and an equipment storage pool (20). The area also includes surge tank plugs (22) and service boxes (24).

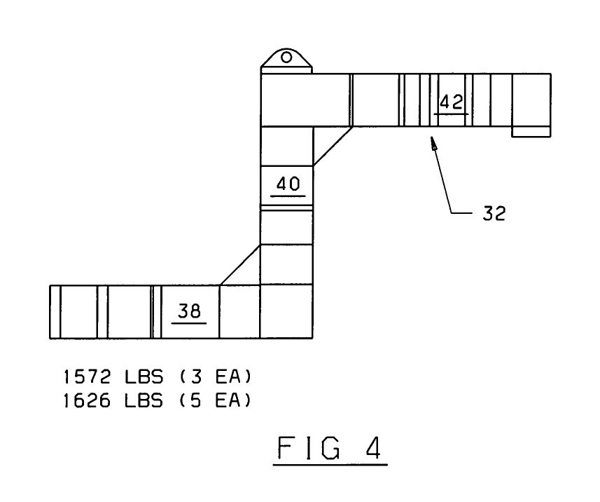

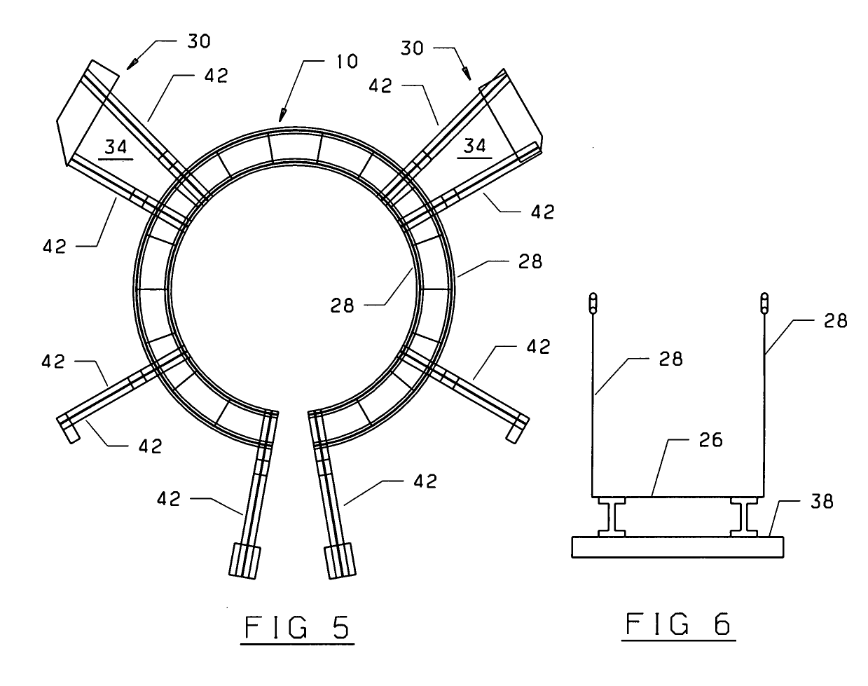

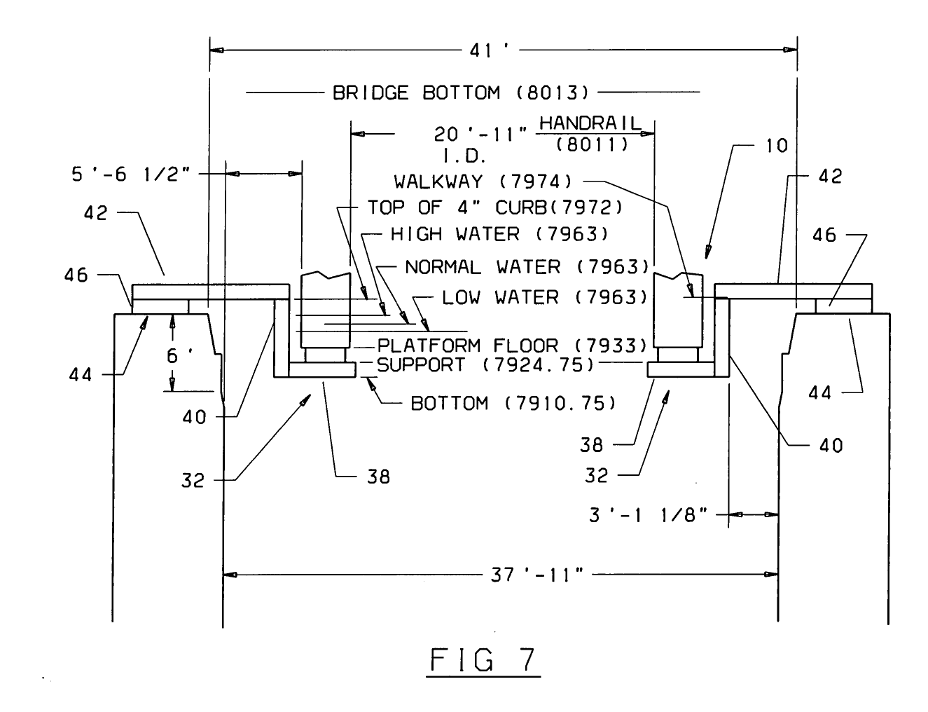

As best seen in FIGS. 1 and 5 the work platform assembly (10) comprises a base platform (26) formed as a 330 degree annulus has hand rails (28) on both sides and two entrance platform assemblies or bridges (30) leading to the main work area. The base platform (26) is approximately 3 ft. wide and 40 in. tall including the hand rails (28) which are made to OSHA requirements. This construction allows approximately six personnel on the platform with their equipment providing a quick inspection/repair due to the simultaneous processes being done by the six people. The platform is designed to clear all floor interferences and the refuel bridge allowing the refueling operation to be conducted simultaneously with the inspection/repair. The overall dimension of the platform bridge is 40.6 ft by 38.7 ft. The base platform (26) is supported on eight s-shaped re-enforced stainless steel channels (32) of welded construction one of which is detailed in FIG. 4. It should be noted that the two bridges (30) are each formed between two short distance spaced s-shaped channel brackets (32) having a floor (34) attached there between and having handrails (36) also attached thereto. Each s-shaped bracket comprises a short leg (38) a vertical leg (40) and a long leg (42). The base platform (26) is welded to Ibeams (44) which are in turn also welded to the short leg ((38) of each s-shaped bracket (32) to form a unitary construction of the brackets (32 and the work platform as a single work platform assembly (10) which can be brought out during refueling from a storage area and placed by a gantry into the reactor cavity for inspection/repair. The placement is best seen in FIG. 7 and it will be understood that t attachment to the rim (44) of the vessel is done through pads (46) in any of known ways.

It will be understood that certain details, obvious modifications and applications have been deleted herein for the sake of conciseness and readability but are fully intended to fall within the scope of the following claims.

1. A portable work platform system for use in a nuclear reactor vessel during refueling operations comprising:
a series of support structures having a first section located able on the rim of the reactor vessel a second section extending down into the vessel and a third section extending out inside the vessel;
a work platform located on said third section of said support structures for providing a work area for a plurality of personnel inside the vessel; and
said work platform and said series of support structures being located in the vessel so as to provide an open area inside said vessel to allow the refueling operation to continue during any work being done by the personnel on the work area.

2. A portable work platform system as set forth in claim 1 including a bridge structure supported between a pair of said support structures for allowing personnel to enter and exit said work platform.

3. A portable work platform system as set forth in claim 1 wherein each of said support structures has said second section spaced away from a wall of the vessel and said third section extending short of a fuel cell area of the vessel to allow the removal and insertion of fuel cells from and into said fuel cell area.

4. A portable work platform system as set forth in claim 3 wherein said work platform is located on said third section of said support structure to allow a view of the wall of the vessel for inspection/repair thereof by the personnel on the work platform during the refueling process.

5. A portable work platform system as set forth in claim 2 wherein each of said support structures is an s-shaped member of re-enforced steel channels made of welded construction to provide strength and light weight.

6. A portable work platform system as set forth in claim 5 wherein said first section is mounted to a rim of the vessel through a series of support pads.

7. A portable work platform system as set forth in claim 3 wherein said work platform is formed as an approximately 330 degree annulus having hand rails on each side of said annulus.

8. A portable work platform system as set forth in claim 7 wherein said work platform is welded to said third section of said support structure.

9. A portable work platform system as set forth in claim 8 including a pair of I-beams welded to said third section and to said work platform to form said work platform and said support structure into a single unit allowing insertion and removal from the vessel as a single unit.

10. A portable work platform system as set forth in claim 9 wherein said support structure is formed form eight spaced s-shaped members.
